(19) United States
(12) Patent Application Publication
(10) Pub. No.: US 2013/0191316 A1
(43) Pub. Date: Jul. 25, 2013

(54) USING THE SOFTWARE AND HARDWARE CONFIGURATIONS OF A NETWORKED COMPUTER TO INFER THE USER'S DEMOGRAPHIC

(71) Applicant: NetAuthority, Inc., San Francisco, CA (US)

(72) Inventor: Craig S. ETCHEGOYEN, Newport Beach, CA (US)

(73) Assignee: NETAUTHORITY, INC., San Francisco, CA (US)

(21) Appl. No.: 13/707,805

(22) Filed: Dec. 7, 2012

Related U.S. Application Data
(60) Provisional application No. 61/568,101, filed on Dec. 7, 2011.

(51) Int. Cl. G06N 5/04

(52) U.S. Cl. CPC G06N 5/04
USPC 706/47

(57) ABSTRACT

System information relating to the hardware and software configuration of a networked client computer is used by a server from which the client computer has requested information to infer demographic characteristics of the user of the client computer. The system information provided to the server gathered from the use of network browser software by the client computer is used by the server to add customized content to the information requested by the client computer. Inferring demographic characteristics of the user involves application of predetermined demographics inference rules stored by the server to the client computer configuration information provided by the client.

### BACKGROUND OF THE INVENTION

This application claims priority pursuant to 35 U.S.C. §119(e) to U.S. provisional application Ser. No. 61/568,101, filed Dec. 7, 2012, which application is specifically incorporated herein, in its entirety, by reference.

1. Field of the Invention

The present invention relates generally to computer network services and, more particularly, to methods of and systems for determining a demographic profile of an unidentified user of a networked computer.

2. Description of Related Art

One of the more important benefits of the current Internet-based world in which we live is mass customization. Exploitation of the mass customization afforded by intelligent interaction with customers through the Internet has led to a large number of successful “long tail” business models. Thus, the ability to customize the experience of each user of Internet-based services is now well-recognized as very important and very valuable.

Of course, such customization requires possession of information about the user before the experience can be customized for that user. Accordingly, the user's experience is rather generic until the user has taken the additional step of identifying herself and/or entering data representing some of her characteristics. Of course, requiring entry by the user of data specifying characteristics of the user is a nuisance. In addition, many users perceive personal questions from web sites to be a bit creepy and to present significant privacy concerns.

The ability to quickly and automatically infer some demographic characteristics of unknown users would significantly enhance such users' experience and would represent a significant advance in the art.

### SUMMARY OF THE INVENTION

In accordance with the present invention, demographic characteristics, and therefore interests and some broad personality characteristics, of an unidentified user of a remotely located client computer are inferred by a server from data representing the software and hardware configurations of the remotely located client computer.

Information relating to the software and hardware configurations and, therefore to the user, is accumulated from data on the remotely located client computer identifying its resident software as well as its primary hardware and any hardware accessories and sent to the server with which the networked client computer is communicating.

The server uses the information about the configurations of the software and hardware data to infer a demographic profile of the user of the remotely located client computer from among profiles stored on the server. This inferred demographic profile allows the server to add customized network content including advertising to information sent at the request of the remotely located client computer. The inferred demographic profile of the user of the remotely located client computer also enables anticipation of changes in the interests of the user.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. In the drawings, like reference numerals may designate like parts throughout the different views, wherein:

FIG. 1 is a diagram showing a client computer and a server computer that cooperate to perform user demographic inference in accordance with one embodiment of the present invention.

FIG. 2 is a transaction flow diagram illustrating the manner in which the client computer and server computer of FIG. 1 cooperate to perform user demographic inference so as to be able to send customized content to the remotely located client computer based on inferred user demographics.

FIG. 3 is a logic flow diagram illustrating the manner in which the client computer creates a user profile in a step of the transaction flow diagram of FIG. 2 in greater detail.

FIG. 4 is a logic flow diagram illustrating the manner in which the server computer infers the user's demographic in a step of the transaction flow diagram of FIG. 2 in greater detail.

FIG. 5 is a block diagram showing in greater detail the server computer of FIG. 1, including demographic reference data.

FIG. 6 is a block diagram showing in greater detail the client computer of FIG. 1, including hardware and software system information.

FIG. 7 is a block diagram of a hardware and software profile data record used by the server computer to represent the user of a remotely located client computer.

FIG. 8 is a block diagram of a demographic inference record used by the server computer that controls the manner in which the server computer infers demographic characteristics of a user from the hardware and software profile.

### DETAILED DESCRIPTION

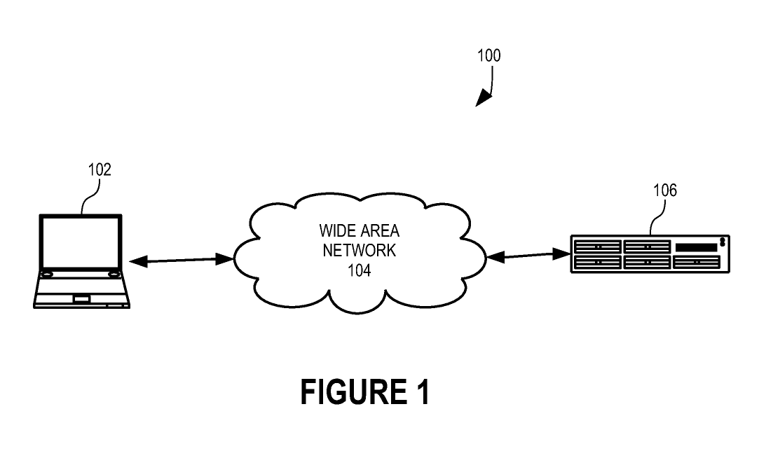

In accordance with the present invention, a server 106 (FIG. 1) can infer demographic characteristics of a user of a remotely located client computer 102 (FIG. 1) without requiring the user to identify herself or provide any demographic information whatsoever. Data representing the hardware and software configurations of client computer 102 is received by server 106 and used to create a demographic profile of the user.

Client computer 102 can be any of a number of types of computer devices, including smartphones, tablets, netbooks, laptops, and desktops. When client computer 102 sends a request to server 106, the request includes data representing system information gathered from system configuration files stored on and information provided by hardware devices installed in client computer 102. Server 106 compares the system information of the remotely located client computer 102 to one or more demographic profiles resident on server 106 so that server 106 can customize content added by server 106 to a response to the request.

Sources of the system information on client computer 102 include both the hardware components of client computer 102 and the software with which it is loaded. Hardware, including computer chips, storage devices, phone components, display screens, user interface, cables, and audio components of smartphones, netbooks, tablets, laptops and desktop vary significantly by price, function and capability. While these variations certainly are found between categories of computers, these variations are also signification within a give category of computer. Software found on various computer devices also vary significantly by price, function and capability and according to computer device category as well as within each category. Such software includes operating systems, browsers and mini-browsers, games, work-related programs—including software used by various professionals—music, and photo and video editors among many other possible capabilities.

The possible variations in hardware and software are so great that it is very unlikely that two computer devices within the same computer device category—for example, two laptops—which happen to have exactly the same hardware and software components when new will continue to do so for very long. As a result, demographic profiles of the users can begin to vary quickly even in that case.

Demographic inference information stored on server 106 is based on one or more widely shared characteristics of individual users, including, for example, age, ethnicity, income, job, gender and geography. But, it should be understood that many other types of characteristics can be used to create more or different demographic profiles.

In a manner described more completely below, server 106 processes the system information gathered by client computer 102 from its hardware and software configurations and infers demographic characteristics of the user, enabling server 106 to send unrequested information likely to be of interest to the user of client computer 102 whether the user has previously shown interest in such information or not. In other words, the demographic characteristics of a user not only make it possible for server 106 to infer the past activities and preferences of the user but also can be likely to be able to predict what the user of the client will want to do in the future—including interest in new products and new ideas, as well as the loss of interest in other products and ideas. This predictive capability is accomplished through the tracking of, for example, a product's life cycle among identified early adopters within the user's demographic group. A change in product preference among early adopters can presage a gradual change in product preference for the entire demographic.

As shown in FIG. 1, client computer 102 and server 106 communicate with one another through a wide area network 104, which is the Internet in this illustrative example.

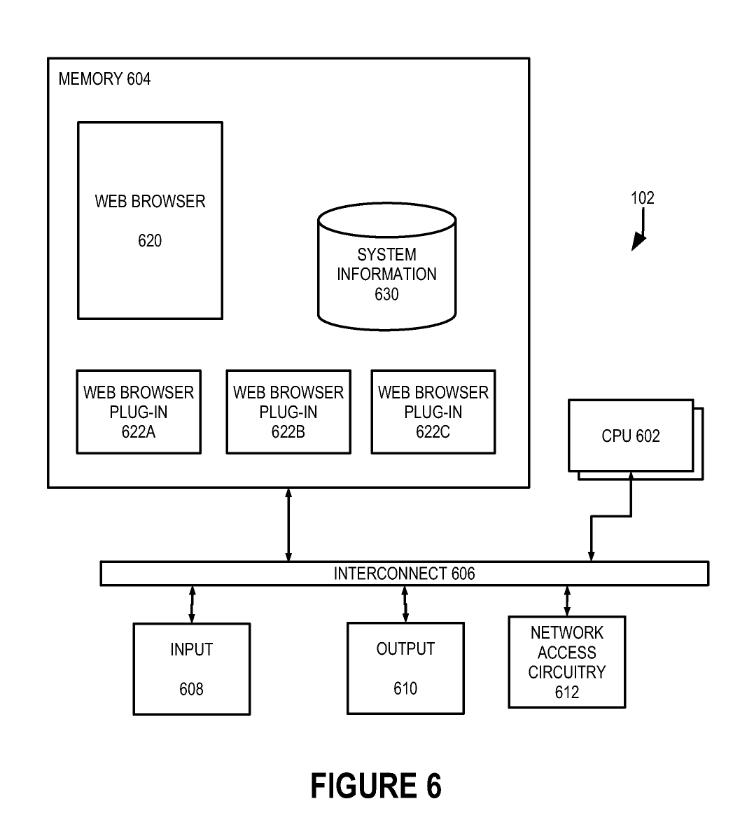

Server 106 (FIG. 1) infers demographic characteristics of the user of client computer 102 in this illustrative example from system information 630 (FIG. 6) stored on client computer 102 (FIG. 1). System information 630 is data maintained in a conventional manner by the operating system of client computer 102 and includes information about the hardware and software configurations of client computer 102.

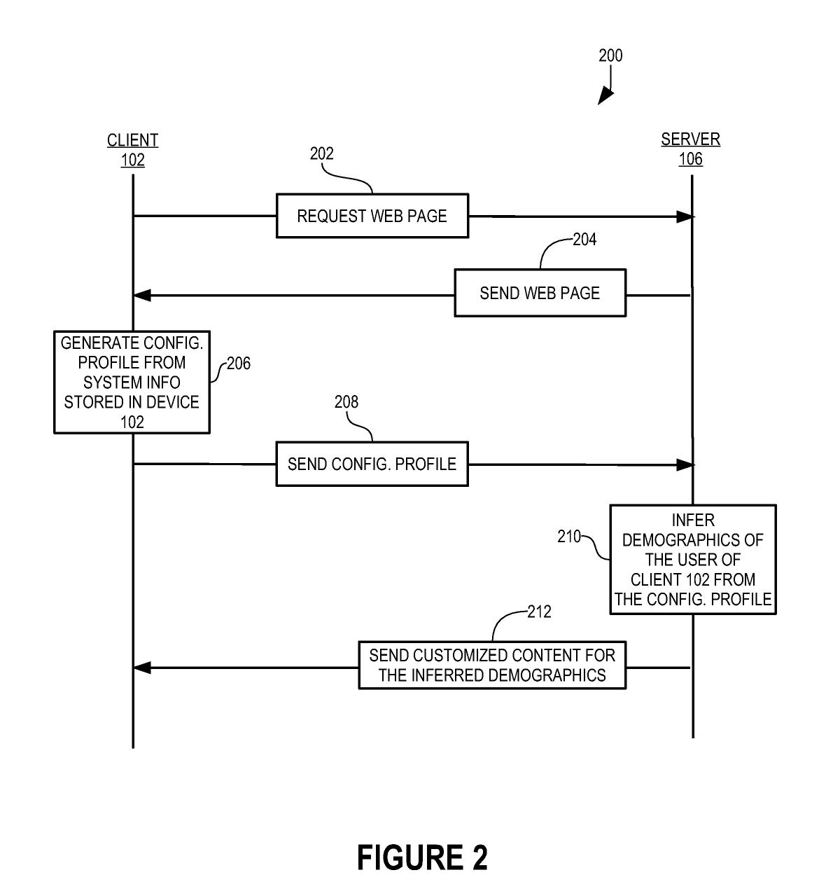

Transaction flow diagram 200 (FIG. 2) represents the manner in which client computer 102 and server 106 cooperate to infer demographic characteristics of the user of client computer 102 in accordance with the present invention.

In step 202, client computer 102 sends a request for a web page to server computer 106. The request can be in the form of a URL specified by the user of client computer 102 using a web browser 620 (FIG. 6) executing in client computer 102 and conventional user interface techniques involving physical manipulation of user input devices 608. Web browser 620 and user input devices 608 and other components of client computer 102 are described in greater detail below.

In step 204 (FIG. 2), server 106 sends the web page that is identified by the request received in step 202. The web page sent to client computer 102 includes content that causes web browser 620 of client computer 102 to generate in step 206 a current hardware and software configuration profile for client computer 102 from system information 630 (FIG. 6). In one embodiment, a web browser plug-in 622C is installed in client computer 102 and, invoked by web browser 620, generates the hardware and software configuration profile from system information 630.

It should be appreciated that some of system information 630 may not be previously gathered and stored by the operating system of client computer 102. Other items of system information can be requested of hardware components of client computer 102 and included in system information. For example, models and capabilities of storage devices and graphics devices can be retrieved from the storage devices and graphics devices themselves as needed. Such querying of hardware components of a computer is known and not described herein.

In addition to hardware components and installed software of client computer 102, system information 630 can include software stored in client computer 102 that is not yet installed. Such nascent software can be identified as files stored in a file system of client computer 102. Other contents of the file system of client computer 102 can be included in system information 630. For example, music, video, and other media stored in a computer can be indicative of demographic characteristics.

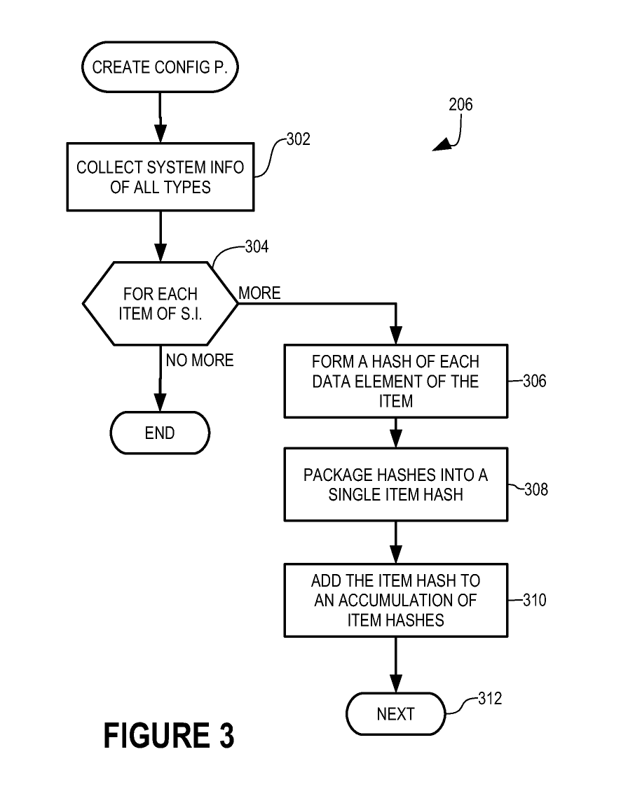

The various elements of client computer 102 and their interaction are described more completely below. In addition, step 206 is described more completely below with respect to logic flow diagram for step 206 (FIG. 3).

In step 208, client computer 102 sends the hardware and software configuration profile that was generated in step 206 to server 106.

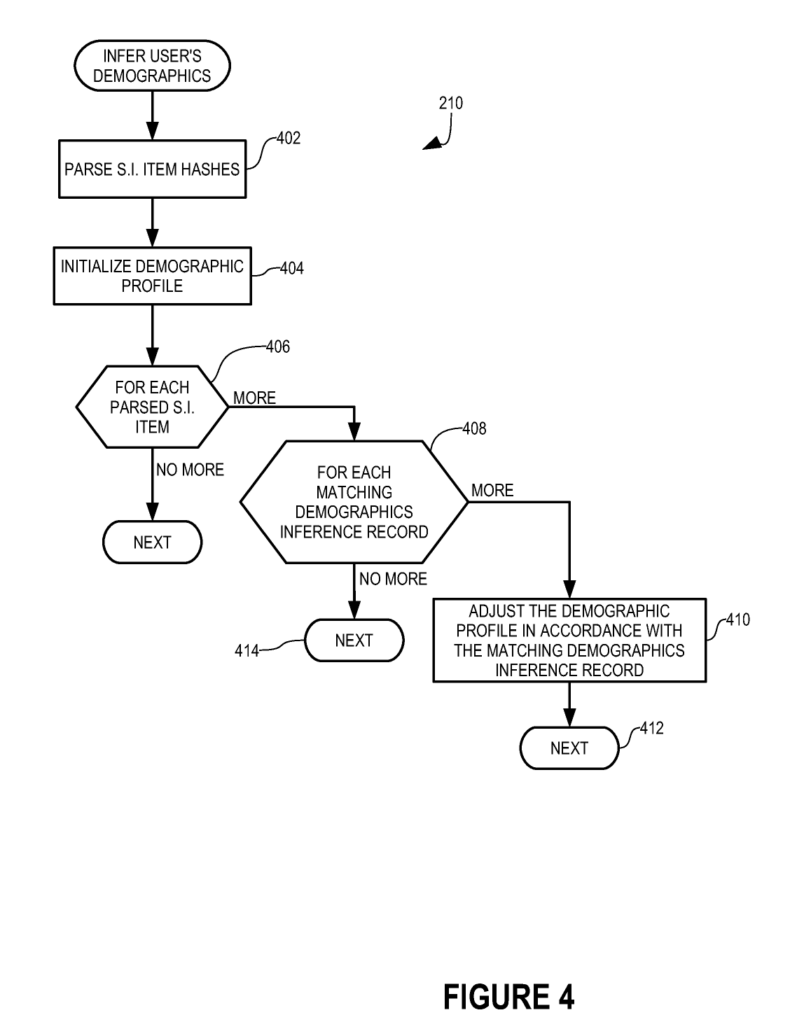

In step 210, server 106 infers one or more demographic characteristics of the user of client computer 102 from the hardware and software configuration profile received in step 208. Step 210 is described in greater detail below in conjunction with logic flow diagram 210 (FIG. 4).

In step 212, server 106 sends content customized according to the one or more inferred demographic characteristics to client computer 102.

As described above, client computer 102 generates a hardware and software configuration profile from system information 630 (FIG. 6) in step 206 (FIG. 2), and step 206 is shown in greater detail as logic flow diagram 206 (FIG. 3). In this illustrative embodiment, step 206 is performed by web browser plug-in 622C (FIG. 6).

In step 302 (FIG. 3), web browser plug-in 622C collects system information of all types from system information 630, which includes a number of items of hardware and software of client computer 102 each having a type and a value. Item types can include generally any type of hardware and software information stored on client computer 102 and used by web browser 620 (FIG. 6), including client computer 102′s computer chips, user interface, display screen, internet access means, memory cards, audio components, web browser or web mini-browser, games, professional software, music, and photo editing and video editing software. Such items represent user activity on client computer 102 and system configuration choices of the user and can be indicative of subjective needs and preferences of the user.

Loop step 304 and next step 312 define a loop in which web browser plug-in 622C processes each item of system information 630 in accordance with steps 304-314. The particular item of system information 630 processed by web browser plug-in 622C during each iteration of the loop of steps 304-314, is sometimes referred to herein as “the subject item”.

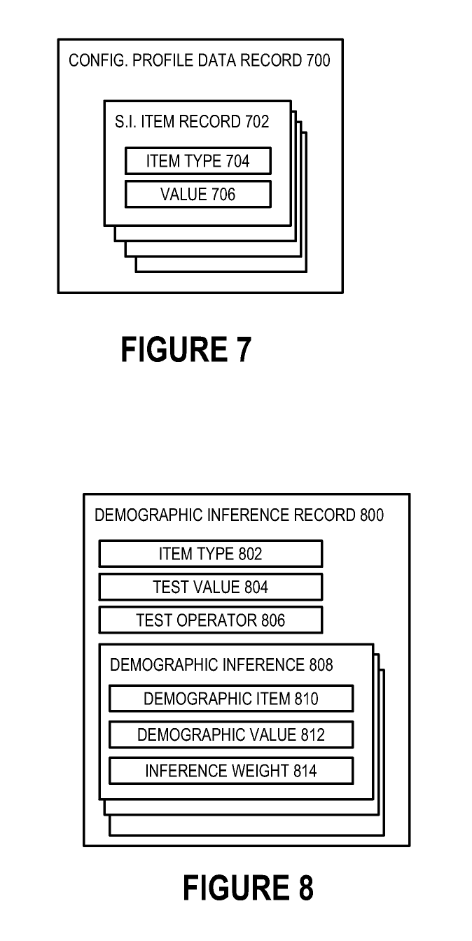

In step 306, web browser plug-in 622C forms a reversible hash of each data element of the subject item. Each data element of the subject item is hashed by web browser plug-in 622C to hide system information during transport through wide area network 104 (FIG. 1). In particular, item type 704 (FIG. 7) of system information item record 702 is a hash of the type of the subject item, and value 706 is a hash of the value of the subject item.

In step 308, web browser plug-in 622C packages all the reversible hashes of data elements of the subject item into a single, reversible hash representing the subject item in its entirety. Web browser plug-in 622C forms system information item record 702 as a hash of item type 704 and value 706 in this illustrative embodiment.

In step 310, web browser plug-in 622C adds the hash created in step 308 to an accumulation of data item hashes. The accumulation of data item hashes is a hardware and software configuration profile of client computer 102 sent to server 106 in step 208.

Once all of system information items 630 (FIG. 6) have been processed by web browser plug-in 622C according to the loop of steps 304-312 (FIG. 3), processing according to logic flow diagram 206, and therefore step 206 (FIG. 2), completes. The resulting hardware and software configuration profile is an accumulation of hashes that represent multiple items of system information stored on client device 102 that represent the subjective needs and preferences of the user.

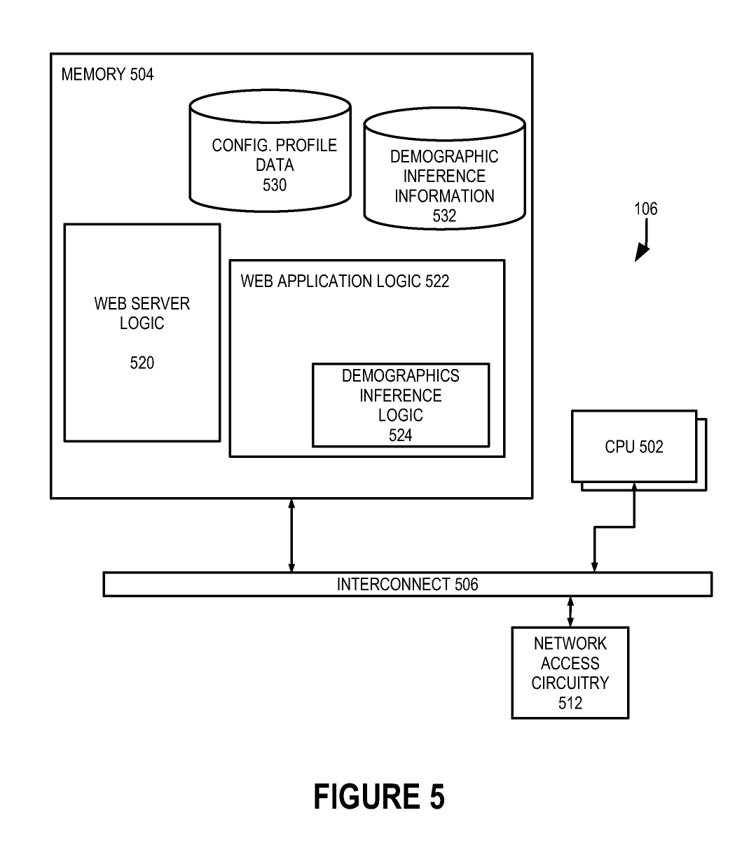

As described above, server 106 (FIG. 1) infers one or more demographic characteristics of the user in step 210 from the hardware and software configuration profile received in step 208 (FIG. 2). This is shown in greater detail as logic flow diagram 210 (FIG. 4). The hardware and software configuration profile is stored by server 106 as a hardware and software configuration profile data record 700 (FIG. 7) in hardware and software configuration profile data 530 (FIG. 5).

In step 402 (FIG. 4), demographic inference logic 524 parses individual reversible hashes representing whole, individual items of system information from the hardware and software configuration profile data 530 and parses the reversible hashes of individual data items from each of the parsed reversible hashes.

In step 404, demographic inference logic 524 initializes a demographics profile. In particular, demographic inference logic 524 represents that all demographic characteristics of the user associated with hardware and software configuration profile record 700 are initialized to be unknown.

Loop step 406 and next step 414 define a loop in which demographic inference logic 524 processes each system information item record 702 of hardware and software configuration profile data record 700 according to steps 408-412. During each iteration of the loop of steps 406-414, the particular system information item processed by demographic inference logic 524 is sometimes referred to as “the subject system information item” in the context of logic flow diagram 210. In the same context, system information record 702 represents the subject system information item. In particular, item type 704 and value 706 represent the type and value, respectively, of the subject system information item.

In loop step 408, demographics inference logic 524 identifies one or more matching demographics inference records, such as demographics inference record 800 (FIG. 8), for the subject system information item. Demographics inference record 800 matches the system information item represented by system information item record 702 if item type 802 and item type 704 are the same and application of test value 804 to value 706 with test operator 806 yields a “true” result.

It may be helpful to consider the following example. Suppose, for example, that item type 802 specifies that a computer game is resident on client computer 102, test value 804 specifies a regular expression, and test operator 806 specifies a regular expression match operation. Demographic inference record 800 would them match system information item record 702 if item type 704 indicates a resident computer game and value 706, e.g., representing the name and/or version of the video game, is matched by the regular expression of test value 804.

For each matching demographics inference record for the subject system information item, processing by demographics inference logic 524 transfers from loop step 408 to step 410.

In step 410, demographics inference logic 524 adjusts the demographic profile according to demographics inference 808 (FIG. 8) of the matching demographics inference record. Demographic item 810 represents a demographic characteristic to be adjusted. Examples include gender, age, annual income, geographic region, and specific interests, including music. For example, if demographic item 810 represents gender, demographic value 812 represents “male” or “female.” Demographic value 812 represents a particular value for demographics item 810. Inference weight 814 represents an amount by which the user's demographic characteristic represented by demographic item 810 is biased toward the value represented by demographic value 812.

In an example, if demographic item 810 represents gender, and demographic value 812 represents male, inference weight 814 is added to an accumulating male gender counter. A comparison of the male gender counter to a female gender counter ultimately decides the likely gender of the user. In addition, a predetermined minimum difference between the male and female gender counters can be required to comfortably infer one gender or the other.

There may, of course, be many different items of system information that suggest gender, including music, games, videos, and work-related software, each of which is considered to suggest a male or female user. Some items will have far more weight as a gender identifier than others. As an example, a computer game such as Grand Theft Auto might suggest a male user, and a preference for Nancy Drew Mystery games might suggest a female user since the players of each are strongly polarized by gender. Of course, a female user can have the violent video game, Grand Theft Auto, installed on her computer. However, there may be many other items in system information 630 that indicate a female gender. Inference weight 814 for many inferences may require careful adjustments to improve accuracy of demographic inferences.

In one embodiment, a demographic value 812 may represent gender as a probability. For example, value 812 may range along a normalized scale from 0 to 100 to represent the probability, where a value of 0 represents 0% probability of the female gender (and therefore 100% probability of the male gender) and a value of 100 represents 100% probability of the female gender (and therefore a 0% probability of the male gender). In practice, values 812 will lie somewhere along the spectrum between 0 and 100. In this embodiment, the actual gender of a user is not important, as a marketing campaign may be primarily interested in the consumer habits of the user that are inferable from the gender score, rather than the gender itself. For example, an advertiser may observe that its products (for whatever reason) appeal mainly to users having a gender score between 40% and 60%.

A compilation of several such similarly strongly indicative items makes it possible for the server to infer one or more personal characteristics of the user. Such characteristics can include income, job, age, and leisure time activities, and, when well-chosen, can be as valuable to demographic inferences as some game choices can be for gender. In the same way that a demographic value for gender may be represented as a probability, so may demographic values for other characteristics be represented in accordance with the invention.

Inferences, such as represented in demographics inference record 800 for example, can be determined empirically by statistical analysis of system information of a number of known users. For example, computer users sometimes voluntarily share detailed demographic information about themselves. Examples include customer surveys for marketing or scientific research and profiles for on-line social networking. When a user voluntarily provides information about her own demographic characteristics, system information such as system information 630 (FIG. 6) is gathered and associated with the user-provided demographic characteristics such that statistical regression can be performed to determine proper demographic inferences from such system information.

When the loop process 406-414 is complete because there are no more system information items to compare to demographics inference records and therefore no further adjustments to be made to the demographic profile of the user of client computer 102, processing by demographics inference logic 524 according to logic flow diagram 210, and therefore step 210 (FIG. 2), completes. The inferred demographic profile of the user is the result of cumulative adjustments made to the demographics profile initialized as neutral in step 404. To the extent the inferred demographics profile of the user suggests one or more demographic characteristics of the user to be inferred with a predetermined degree of certainty, web application logic 522 can select content specifically tailored to users of those demographics characteristics.

While broadly applicable to use on the World Wide Web, the invention is also useful for other applications, including intranets. A corporate intranet wishing to tailor information to users in different departments could identify the appropriate users according to the software and/or hardware of an individual requesting information from the intranet server. For example, if sales people were all issued the same handheld computer devices and/or had software shared by no other department, new information affecting only the sales personnel—such as promotions, new job openings and reminders of impending product releases—could accompany the response to any requests to the intranet server.

The hardware and software configuration of the computer devices of the great majority of users is sufficiently similar as to make it possible to limit the number of different predetermined demographics profiles while still accurately anticipating the interests of the users of client computers on a network. Since some users are early adopters of new products and ideas, other users with the same demographic profile can be predicted to eventually make the same changes. Tracking persisting new variations in personal data from a demographic profile provides a clue to the future behavior of others with the same profile. Information on known early adopters is manually entered into the demographic profile data resident on server 106. In one embodiment, early adopters are identified by new items that do not find a match at step 408 in demographics inference records 800.

Server computer 106 is shown in greater detail in FIG. 5. Server 106 includes one or more microprocessors 502 (collectively referred to as CPU 502) that retrieve data and/or instructions from memory 504 and execute retrieved instructions in a conventional manner. Memory 504 can include generally any computer-readable medium including, for example, persistent memory such as magnetic and/or optical disks, ROM, and PROM and volatile memory such as RAM.

CPU 502 and memory 504 are connected to one another through a conventional interconnect 506, which is a bus in this illustrative embodiment and which connects CPU 502 and memory 504 to network access circuitry 512. Network access circuitry 512 sends and receives data through computer networks such as wide area network 104 (FIG. 1).

A number of components of server 106 are stored in memory 504. In particular, web server logic 520 and web application logic 522, including demographics inference logic 524, are all or part of one or more computer processes executing within CPU 502 from memory 504 in this illustrative embodiment but can also be implemented using digital logic circuitry.

Web server logic 520 is a conventional web server. Web application logic 522 is content that defines one or more pages of a web site and is served by web server logic 520 to client devices such as client computer 102. The one or more pages of a web site served by web application logic 522 can include both static and dynamic content. The dynamic content is to be executed by web browser 620 (FIG. 6) of client computer 102, either directly or through a plug-in such as plug-ins 622A-C. Demographics inference logic 524 (FIG. 5) is a part of web application logic 522 that infers one or more demographic characteristics of users of client computers in the manner described above.

Client computer 102 is a personal computing device and is shown in greater detail in FIG. 6. Client computer 102 includes one or more microprocessors 602 (collectively referred to as CPU 602) that retrieve data and/or instructions from memory 604 and execute retrieved instructions in a conventional manner. Memory 604 can include generally any computer-readable medium including, for example, persistent memory such as magnetic and/or optical disks, ROM, and PROM and volatile memory such as RAM.

CPU 602 and memory 604 are connected to one another through a conventional interconnect 606, which is a bus in this illustrative embodiment and which connects CPU 602 and memory 604 to one or more input devices 608, output devices 610, and network access circuitry 612. Input devices 608 can include, for example, a keyboard, a keypad, a touch-sensitive screen, a mouse, a microphone, and one or more cameras. Output devices 610 can include, for example, a display—such as a liquid crystal display (LCD)—and one or more loudspeakers. Network access circuitry 612 sends and receives data through computer networks such as wide area network 104 (FIG. 1).

A number of components of client computer 102 are stored in memory 604. In particular, web browser 620 is all or part of one or more computer processes executing within CPU 602 from memory 604 in this illustrative embodiment but can also be implemented using digital logic circuitry. As used herein, “logic” refers to (i) logic implemented as computer instructions and/or data within one or more computer processes and/or (ii) logic implemented in electronic circuitry. Web browser plug-ins 622A-C are each all or part of one or more computer processes that cooperate with web browser 620 to augment the behavior of web browser 620. The manner in which behavior of a web browser is augmented by web browser plug-ins is conventional and known and is not described herein.

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. A method for characterizing a user of the remotely located computer, the method comprising:
receiving system information from the remotely located computer, wherein the system information includes one or more items of data representing the system configuration of the remotely located computer;
for each of the items of data of the system information data:
determining that one or more predetermined demographic characteristic inference rules apply to the item of data; and
adjusting one or more demographic characteristic inferences of the user according to the applicable predetermined demographic characteristic inference rules; and
inferring one or more demographics characteristics of the user from the demographic characteristic inferences.

2. The method of claim 1 wherein the system information includes data identifying hardware components or software components or media stored on the remotely located computer.

3. The method of claim 1 wherein the system information data on the remotely located computer is gathered by a browser that executes in the remotely located computer.

4. The method of claim 1 wherein the demographic characteristics of the user of the remotely located computer inferred from data from the remotely located computer is used to send customized content to the remotely located computer.

5. The method of claim 1 wherein the inference rules each include a demographic value and inference weight;
wherein adjusting of a selected one of the demographic characteristic inferences according to a selected one of the inference rules comprises adjusting the selected demographic characteristic inference toward the demographic value of the selected inference rule to a degree specified by the inference weight of the selected inference rule; and
wherein the demographic value and inference weight are predetermined based on empirical evidence.

6. A computer readable medium useful in association with a computer which includes one or more processors and a memory, the computer readable medium including computer instructions which are configured to cause the computer, by execution of the computer instructions in the one or more processors from the memory, to characterize a user of the remotely located computer by at least:
receiving system information from the remotely located computer, wherein the system information includes one or more items of data representing the system configuration of the remotely located computer;
for each of the items of data of the system information data:
determining that one or more predetermined demographic characteristic inference rules apply to the item of data; and
adjusting one or more demographic characteristic inferences of the user according to the applicable predetermined demographic characteristic inference rules; and
inferring one or more demographics characteristics of the user from the demographic characteristic inferences.

7. The computer readable medium of claim 6 wherein the system information includes data identifying hardware components or software components or media stored on the remotely located computer.

8. The computer readable medium of claim 6 wherein the system information data on the remotely located computer is gathered by a browser that executes in the remotely located computer.

9. The computer readable medium of claim 6 wherein the demographic characteristics of the user of the remotely located computer inferred from data from the remotely located computer is used to send customized content to the remotely located computer.

10. The computer readable medium of claim 6 wherein the inference rules each include a demographic value and inference weight;
wherein adjusting of a selected one of the demographic characteristic inferences according to a selected one of the inference rules comprises adjusting the selected demographic characteristic inference toward the demographic value of the selected inference rule to a degree specified by the inference weight of the selected inference rule; and
wherein the demographic value and inference weight are predetermined based on empirical evidence.

11. A computer system comprising:
at least one processor;
a computer readable medium that is operatively coupled to the processor;
network access circuitry that is operatively coupled to the processor; and
demographic inference logic (i) that executes at least in part in the processor from the computer readable medium and (ii) that, when executed, causes the computer system to characterize a user of the remotely located computer by at least:
receiving system information from the remotely located computer, wherein the system information includes one or more items of data representing the system configuration of the remotely located computer;
for each of the items of data of the system information data:
determining that one or more predetermined demographic characteristic inference rules apply to the item of data; and
adjusting one or more demographic characteristic inferences of the user according to the applicable predetermined demographic characteristic inference rules; and
inferring one or more demographics characteristics of the user from the demographic characteristic inferences.

12. The computer system of claim 11 wherein the system information includes data identifying hardware components or software components or media stored on the remotely located computer.

13. The computer system of claim 11 wherein the system information data on the remotely located computer is gathered by a browser that executes in the remotely located computer.

14. The computer system of claim 11 wherein the demographic characteristics of the user of the remotely located computer inferred from data from the remotely located computer is used to send customized content to the remotely located computer.

15. The computer system of claim 11 wherein the inference rules each include a demographic value and inference weight;
wherein adjusting of a selected one of the demographic characteristic inferences according to a selected one of the inference rules comprises adjusting the selected demographic characteristic inference toward the demographic value of the selected inference rule to a degree specified by the inference weight of the selected inference rule; and
wherein the demographic value and inference weight are predetermined based on empirical evidence.
